(19) United States
(12) Patent Application Publication
(10) Pub. No.: US 2026/0244057 A1
(43) Pub. Date: Aug. 20, 2026

(54) DISPLAY PANEL

(71) Applicant: HannStar Display Corporation, Taipei City (TW)

(72) Inventors: Jing-Ya Chiu, Taipei City (TW); Shao-Chien Chang, Taipei City (TW); Qi-En Luo, Taipei City (TW); Ying-Jung Chen, Taipei City (TW); Ling Chih Kao, Taipei City (TW); Cheng-Yen Yeh, Taipei City (TW)

(73) Assignee: HannStar Display Corporation, Taipei City (TW)

(21) Appl. No.: 19/370,753

(22) Filed: Oct. 28, 2025

(30) Foreign Application Priority Data
Feb. 19, 2025 (TW) 114106042

(51) Int. Cl. G02F 1/1362

(52) U.S. Cl. CPC G02F 1/136213

(57) ABSTRACT

A display panel of the disclosure includes a first substrate, a pixel structure and an insulation layer. The pixel structure is disposed on the first substrate and is provided with a reflective area and a transmissive area. The pixel structure includes an active device, a first transparent electrode, a reflective layer and a second transparent electrode. The first transparent electrode and the second transparent electrode are disposed overlapping the transmissive area. The second transparent electrode is located between the first transparent electrode and the first substrate. The reflective layer is disposed on the active device and defines the reflective area. The insulation layer is disposed between the first transparent electrode and the second transparent electrode. The first transparent electrode or the second transparent electrode is electrically connected to the active device. The first transparent electrode is electrically coupled with the second transparent electrode to form a storage capacitor.

### CROSS-REFERENCE TO RELATED APPLICATION

This application claims the priority benefit of Taiwan application serial no. 114106042, filed on February 19, 2025. The entirety of the above-mentioned patent application is hereby incorporated by reference herein and made a part of this specification.

### BACKGROUND

### Technical Field

The disclosure relates to a display technology, and in particular, to a display panel.

### Description of Related Art

A pixel structure is the smallest driving unit used by a display panel to present images. To ensure that the driving signal of the pixel structure remains at a stable level within a predetermined time interval, the pixel structure is usually provided with a storage capacitor. As efforts continue to improve display quality, the size of pixel structures is constantly being reduced, which in turn compresses the layout space available for storage capacitors. Especially for a transflective display panel, the storage capacitor thereof is typically arranged within the reflective area. If the proportion of the transmissive area in the pixel structure is to be increased, the proportion of the reflective area must inevitably be reduced. Consequently, the storage capacitance of the pixel structure will also be reduced, leading to a deterioration in display quality of the display panel under low-frequency driving.

### SUMMARY

The disclosure provides a display panel with a more flexible adjustment of the ratio between the transmissive area and the reflective area of a pixel structure while still maintaining a sufficient storage capacitance.

A display panel of the disclosure includes a first substrate, a pixel structure and an insulation layer. The pixel structure is disposed on the first substrate and is provided with a reflective area and a transmissive area. The pixel structure includes an active device, a first transparent electrode, a reflective layer and a second transparent electrode. The first transparent electrode and the second transparent electrode are disposed overlapping the transmissive area. The second transparent electrode is located between the first transparent electrode and the first substrate. The reflective layer is disposed on the active device and defines the reflective area. The insulation layer is disposed between the first transparent electrode and the second transparent electrode. The first transparent electrode or the second transparent electrode is electrically connected to the active device. The first transparent electrode is electrically coupled with the second transparent electrode to form a storage capacitor.

In an embodiment of the disclosure, the first transparent electrode and the second transparent electrode of the display panel are arranged to overlap the reflective area. The first transparent electrode is electrically connected to the active device.

In an embodiment of the disclosure, the display panel further includes an overcoat layer disposed between the first transparent electrode and the first substrate and covering the active device. The second transparent electrode is disposed between the insulation layer and the overcoat layer.

In an embodiment of the disclosure, the pixel structure of the display panel further includes a common electrode disposed between the overcoat layer and the first transparent electrode and located in the reflective area. The second transparent electrode extends into the reflective area and directly contacts the common electrode.

In an embodiment of the disclosure, the pixel structure of the display panel further includes a capacitor electrode located in the reflective area and extending from a drain electrode of the active device. The common electrode is electrically coupled with the capacitor electrode to form another storage capacitor.

In an embodiment of the disclosure, the display panel further includes a second substrate, a common electrode and a liquid crystal layer. The second substrate is disposed overlapping the first substrate. The common electrode is disposed on the second substrate. The liquid crystal layer is disposed between the first substrate and the second substrate. The overcoat layer has an opening located in the transmissive area. A thickness of the liquid crystal layer in the transmissive area is greater than a thickness of the liquid crystal layer in the reflective area.

In an embodiment of the disclosure, the first transparent electrode of the display panel is provided with a plurality of micro slits in the transmissive area. The common electrode layer has an electrode opening overlapping the transmissive area.

In an embodiment of the disclosure, the reflective layer and the second transparent electrode of the display panel are the same film layer and are electrically connected to each other.

In an embodiment of the disclosure, a thickness of the second transparent electrode of the display panel is less than a thickness of the reflective layer.

In an embodiment of the disclosure, the materials of the second transparent electrode and the reflective layer of the display panel include silver.

In an embodiment of the disclosure, the first transparent electrode of the display panel is electrically coupled with the reflective layer to form another storage capacitor.

In an embodiment of the disclosure, the display panel further includes an overcoat layer disposed between the first transparent electrode and the first substrate and covering the active device. The overcoat layer has an opening located in the transmissive area. The second transparent electrode is disposed between the overcoat layer and the first substrate.

In an embodiment of the disclosure, the display panel further includes a second substrate, a common electrode and a liquid crystal layer. The second substrate is disposed overlapping the first substrate. The common electrode is disposed on the second substrate. The liquid crystal layer is disposed between the first substrate and the second substrate. A thickness of the liquid crystal layer in the transmissive area is greater than a thickness of the liquid crystal layer in the reflective area.

In an embodiment of the disclosure, the first transparent electrode of the display panel is provided with a plurality of micro slits in the transmissive area, and the common electrode layer has an electrode opening overlapping the transmissive area.

In an embodiment of the disclosure, the pixel structure of the display panel further includes a capacitor electrode and a common electrode. The capacitor electrode is located in the reflective area and extends from a drain electrode of the active device. The common electrode is disposed between the capacitor electrode and the first substrate and is located in the reflective area. The common electrode overlaps the capacitor electrode.

In an embodiment of the disclosure, the first transparent electrode of the display panel extends into the reflective area and is electrically connected to the capacitor electrode. The second transparent electrode is electrically connected to the common electrode. The capacitor electrode is electrically coupled with the common electrode to form another storage capacitor.

In an embodiment of the disclosure, the pixel structure further includes a third transparent electrode. The third transparent electrode is disposed overlapping the reflective area and is electrically connected to the capacitor electrode.

In an embodiment of the disclosure, the first transparent electrode and the third transparent electrode of the display panel are the same film layer and are electrically independent of each other.

In an embodiment of the disclosure, the second transparent electrode of the display panel is electrically connected to the capacitor electrode. The capacitor electrode is electrically coupled with the common electrode to form another storage capacitor.

In an embodiment of the disclosure, the first transparent electrode of the display panel extends into the reflective area and is electrically connected to the reflective layer.

Based on the above, in a display panel according to an embodiment of the disclosure, a transmissive are of a pixel structure is provided with a first transparent electrode and a second transparent electrode. The first transparent electrode is electrically coupled with the second transparent electrode to form a storage capacitor electrically connected to an active device. Since the storage capacitor can be arranged to overlap the transmissive area, the ratio adjustment between a reflective area and the transmissive area of the pixel structure is no longer restricted by the demand for a storage capacitor, which helps to increase the design flexibility of the pixel structure when taking into account both optical and electrical performance.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic front view of a display panel according to a first embodiment of the disclosure.

FIG. 2 is a schematic cross-sectional view of the display panel of FIG. 1.

FIG. 3 is a schematic cross-sectional view of a display panel according to a second embodiment of the disclosure.

FIG. 4 is a schematic front view of a display panel according to a third embodiment of the disclosure.

FIG. 5 is a schematic cross-sectional view of the display panel of FIG. 4.

FIG. 6 is a schematic front view of a display panel according to a fourth embodiment of the disclosure.

FIG. 7 is a schematic cross-sectional view of the display panel of FIG. 6.

FIG. 8 is a schematic front view of a display panel according to a fifth embodiment of the disclosure.

FIG. 9 is a schematic cross-sectional view of the display panel of FIG. 8.

FIG. 10 is a schematic front view of a display panel according to a sixth embodiment of the disclosure.

FIG. 11 is a schematic cross-sectional view of the display panel of FIG. 10.

FIG. 12 is a schematic front view of a display panel according to a seventh embodiment of the disclosure.

FIG. 13 is a schematic cross-sectional view of the display panel of FIG. 12.

### DESCRIPTION OF THE EMBODIMENTS

The aforementioned technical contents, features and effects of the disclosure will be clearly presented in the following detailed description of a preferred embodiment with reference to the drawings. The directional terms used in the following embodiments, such as up, down, left, right, front, or rear, are for reference to the directions indicated in the accompanying drawings. Therefore, these directional terms are used for explanation purposes and not for limiting the scope of the invention.

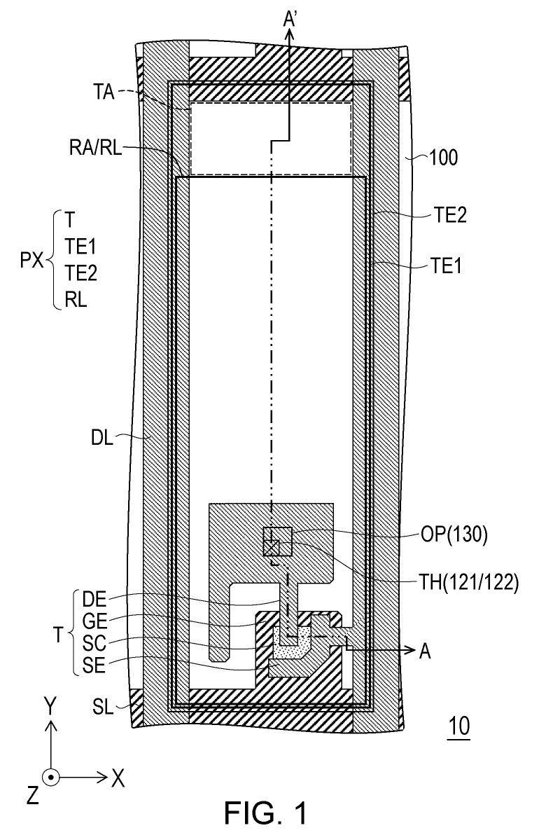

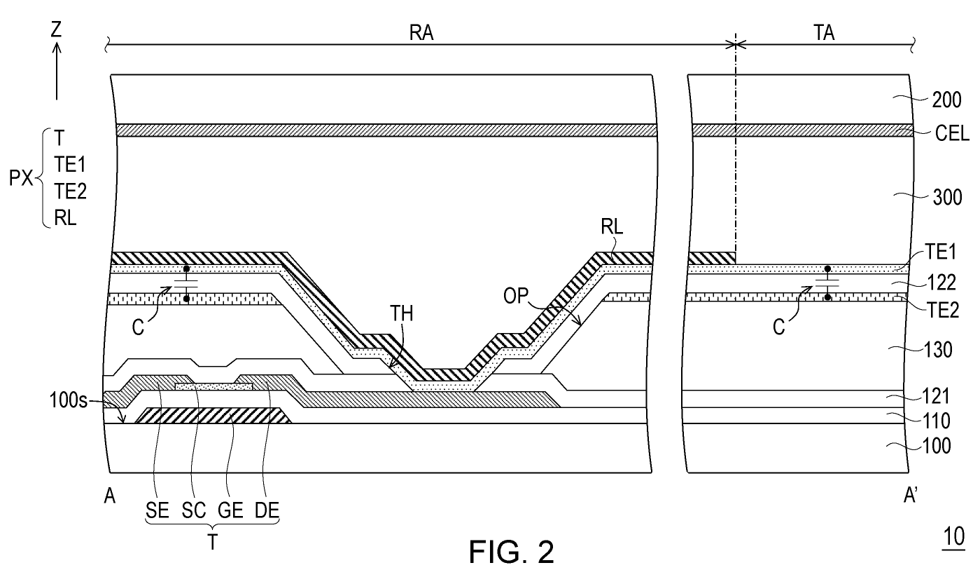

FIG. 1 is a schematic front view of a display panel according to a first embodiment of the disclosure. FIG. 2 is a schematic cross-sectional view of the display panel of FIG. 1. FIG. 2 corresponds to a section line A-A’ of FIG. 1. For clarity, FIG. 1 omits the illustrations of the second substrate 200 and the liquid crystal layer 300 in FIG. 2.

Referring to FIG. 1 and FIG. 2, a display panel 10 includes a first substrate 100, a second substrate 200 and a liquid crystal layer 300. The liquid crystal layer 300 is disposed between the first substrate 100 and the second substrate 200. That is, the display panel 10 of the embodiment is a liquid crystal display panel, but the disclosure is not limited thereto.

Furthermore, a plurality of scan lines SL, a plurality of data lines DL and a plurality of pixel structures PX may be disposed on the first substrate 100. The pixel structure PX is electrically connected to a scan line SL and a data line DL. Although FIG. 1 only illustrates one pixel structure PX of the display panel 10, it is understandable that the display panel 10 may be composed of a plurality of pixel structures PX arranged in an array. For example, the plurality of pixel structures PX may be arranged in a plurality of rows and a plurality of columns along a direction X and a direction Y, respectively. The plurality of data lines DL may be arranged along the direction X and each extend in the direction Y. The plurality of scan lines SL may be arranged along the direction Y and each extend in the direction X. The direction X is not parallel to the direction Y. In the embodiment, the direction X may be selectively perpendicular to the direction Y, but the disclosure is not limited thereto.

The pixel structure PX includes an active device T. The active device T has a source electrode SE, a drain electrode DE, a gate electrode GE and a semiconductor pattern SC. The method of forming the active device T, for example, includes sequentially forming a gate electrode GE, a gate insulation layer 110, a semiconductor pattern SC, a source electrode SE, and a drain electrode DE on the first substrate 100, but the disclosure is not limited thereto. The source electrode SE and the drain electrode DE are electrically connected to two different regions of the semiconductor pattern SC respectively. The source electrode SE is electrically connected to a corresponding data line DL. The gate electrode GE is electrically connected to a corresponding scan line SL. More specifically, a portion of the scan line SL extending to a corresponding pixel structure PX serves as the gate electrode GE of the active device T, and a portion of the data line DL extending to the corresponding pixel structure PX serves as the source electrode SE of the active device T.

The semiconductor pattern SC may serve as a channel layer of the active device T. The material of the semiconductor pattern SC may include amorphous silicon semiconductor, single-crystal silicon semiconductor, polycrystalline silicon semiconductor, or metal oxide semiconductor. In the embodiment, the active device T is, for example, an amorphous silicon thin film transistor (a-Si TFT), but the disclosure is not limited thereto. In other embodiment, the active device T may be a polycrystalline silicon thin film transistor (poly-Si TFT) or a metal oxide semiconductor TFT.

In the embodiment, the gate electrode GE may be selectively disposed under the semiconductor pattern SC to form a bottom-gate thin film transistor, but the disclosure is not limited thereto. In other embodiment, the gate electrode GE may be disposed above the semiconductor pattern SC to form a top-gate thin film transistor. For considerations of conductivity, the scan line SL, the data line DL, and the source electrode SE, drain electrode DE, and gate electrode GE of the active device T are generally made of metal (e.g., molybdenum, aluminum, copper, nickel, chromium), alloys, nitrides of metal materials, oxides of metal materials, oxynitrides of metal materials, or other suitable materials, or stacked layers of metal materials and other conductive materials. The material of the gate insulation layer 110 includes, for example, silicon oxide, silicon nitride or other suitable dielectric materials.

First of all, the pixel structure PX may be provided with a reflective area RA and a transmissive area TA. That is, the display panel 10 of the embodiment may be a transflective display panel. In the embodiment, the pixel structure PX further includes a first transparent electrode TE1, a second transparent electrode TE2 and a reflective layer RL. The reflective layer RL is disposed on the active device T and is located in the reflective region RA. The first transparent electrode TE1 and the second transparent electrode TE2 are disposed to overlap the transmissive area TA and the reflective area RA along a direction Z. Hereinafter, unless specifically mentioned, the overlapping relationship between two components is defined along the direction Z, and the overlapping direction will not be described in detail.

From another perspective, the reflective area RA of the pixel structure PX can be defined by the distribution range of the reflective layer RL, and the portion of the first transparent electrode TE1 that does not overlap the reflective layer RL, the data line DL and the scan line SL can define the transmissive area TA (as shown in FIG. 1) of the pixel structure PX. In the embodiment, the reflective layer RL may directly cover and be electrically connected to the first transparent electrode TE1. The materials of the first transparent electrode TE1 and the second transparent electrode TE2 include metal oxides, such as indium tin oxide, indium zinc oxide, aluminum tin oxide, aluminum zinc oxide, or other suitable oxides, or a stacked layer of at least two of the above. The material of the reflective layer RL includes, for example, silver, silver alloy, or other materials with high reflectivity.

The first transparent electrode TE1 is disposed between the liquid crystal layer 300 and the first substrate 100. The second transparent electrode TE2 is disposed between the first transparent electrode TE1 and the first substrate 100. In the embodiment, the first transparent electrode TE1 may be electrically connected to the drain electrode DE of the active device T. That is, the first transparent electrode TE1 may serve as a pixel electrode of the pixel structure PX. It is particularly noted that, in the embodiment, the first transparent electrode TE1 may be electrically coupled with the second transparent electrode TE2 to form a storage capacitor C of the pixel structure PX.

Since the storage capacitor C of the embodiment can be arranged to overlap both the transmissive area TA and the reflective area RA, the ratio adjustment between the reflective area RA and the transmissive area TA of the pixel structure PX is no longer restricted by the demand for the storage capacitor C, which helps to increase the design flexibility of the pixel structure PX when taking into account both optical and electrical performance.

For example, in the embodiment, an insulation layer 121, an insulation layer 122 and an overcoat layer 130 may be disposed between the first transparent electrode TE1 and the first substrate 100. The insulation layer 121 and the overcoat layer 130 cover the active device T, and the insulation layer 121 is located between the overcoat layer 130 and the active device T. The overcoat layer 130 has an opening OP overlapping the reflective area RA. In the embodiment, the second transparent electrode TE2 may be disposed on the overcoat layer 130, and the insulation layer 122 is disposed between the first transparent electrode TE1 and the second transparent electrode TE2. That is, the second transparent electrode TE2 is located between the insulation layer 122 and the overcoat layer 130. For example, the first transparent electrode TE1 may be disposed between the reflective layer RL and the insulation layer 122, and electrically connected to the drain electrode DE of the active device T through the opening OP of the overcoat layer 130 and the through hole TH of the insulation layer 121 and the insulation layer 122.

The overcoat layer 130 is, for example, an organic insulation layer, and its material includes, for example, polyester, polyolefin, polyacryl, polycarbonate, polyalkylene oxide, polystyrene, polyether, polyketone, polyalcohol, polyaldehyde, or other suitable materials, or combinations thereof. The insulation layer 121 and the insulation layer 122 are, for example, inorganic insulation layers, and the materials thereof include, for example, silicon nitride, silicon oxide, or aluminum oxide, but the disclosure is not limited thereto.

Furthermore, the display panel 10 may further include a common electrode layer CEL disposed on a surface of the second substrate 200 facing the liquid crystal layer 300, i.e., the common electrode layer CEL is located between the second substrate 200 and the liquid crystal layer 300. In the embodiment, the common electrode layer CEL may receive a common voltage, but the disclosure is not limited thereto. The common electrode layer CEL is, for example, a light-transmissive electrode, and the material of the light-transmissive electrode includes, for example, metal oxide (e.g., indium tin oxide, indium zinc oxide, aluminum tin oxide, aluminum zinc oxide, or other suitable oxides, or a stacked layer of at least two of the above), but the disclosure is not limited thereto. For example, the electric field formed between the first transparent electrode TE1 (i.e., the pixel electrode) and the common electrode layer CEL can control the orientations of the liquid crystal molecules in the liquid crystal layer 300, thereby displaying the corresponding image.

Other embodiments will be listed below to explain the present disclosure in detail, wherein the same components will be marked with the same symbols, and the description of the same technical content will be omitted. For the omitted parts, please refer to the aforementioned embodiments and will not be repeated below.

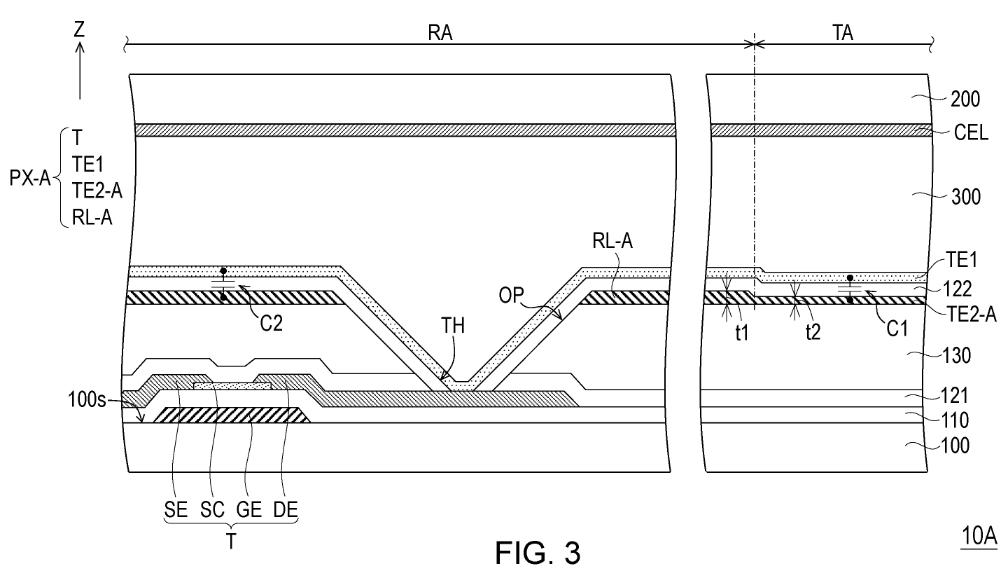

FIG. 3 is a schematic cross-sectional view of a display panel according to a second embodiment of the disclosure. Referring to FIG. 3, the difference between a display panel 10A of the embodiment and the display panel 10 of FIG. 2 lies in that the configuration of the reflective layer is different. Specifically, in the display panel 10A of the embodiment, the reflective layer RL-A and the second transparent electrode TE2-A of the pixel structure PX-A may be the same film layer and are electrically connected to each other.

For example, in the embodiment, the reflective layer RL-A may be disposed between the overcoat layer 130 and the insulation layer 122, and the materials of the reflective layer RL-A and the second transparent electrode TE2-A include, for example, silver, silver alloy, or other conductive materials with high reflectivity. It should be noted that the reflective layer RL-A and the second transparent electrode TE2-A have a thickness t1 and a thickness t2, respectively, along a normal direction (e.g., direction Z) of a substrate surface 100s of the first substrate 100, and the thickness t2 of the second transparent electrode TE2-A is less than the thickness t1 of the reflective layer RL-A. Since the second transparent electrode TE2-A is thin enough, it still has a certain transmittance for visible light.

In the embodiment, in addition to being electrically coupled with the second transparent electrode TE2-A in the transmissive area TA to form a storage capacitor C1, the first transparent electrode TE1 can also be electrically coupled with the reflective layer RL-A in the reflective area RA to form another storage capacitor C2. That is, in the embodiment, the storage capacitor of the pixel structure PX-A is formed by connecting the storage capacitor C1 in the transmissive area TA and the storage capacitor C2 in the reflective area RA in parallel.

Since the storage capacitor of the embodiment can be arranged to overlap both the transmissive area TA and the reflective area RA, the ratio adjustment between the reflective area RA and the transmissive area TA of the pixel structure PX-A is no longer restricted by the demand for the storage capacitor, which helps to increase the design flexibility of the pixel structure PX-A when taking into account both optical and electrical performance.

From another point of view, the portion of the second transparent electrode TE2 located in the reflective area RA of FIG. 2 may be replaced by the reflective layer RL-A of the embodiment. Therefore, in the embodiment, the reflective layer RL as shown in FIG. 2 does not need to be disposed on the first transparent electrode TE1. That is, compared to the display panel 10 in FIG. 2, the display panel 10A of the embodiment may have a simplified manufacturing process.

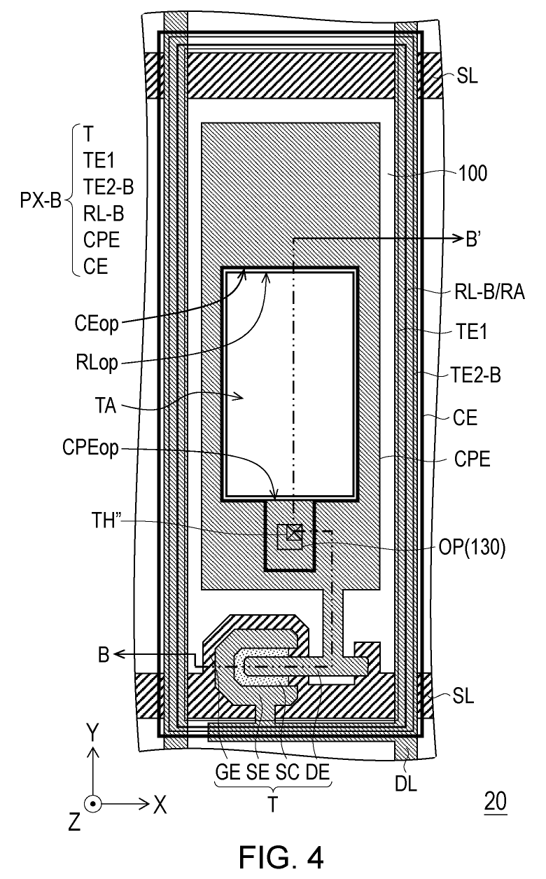

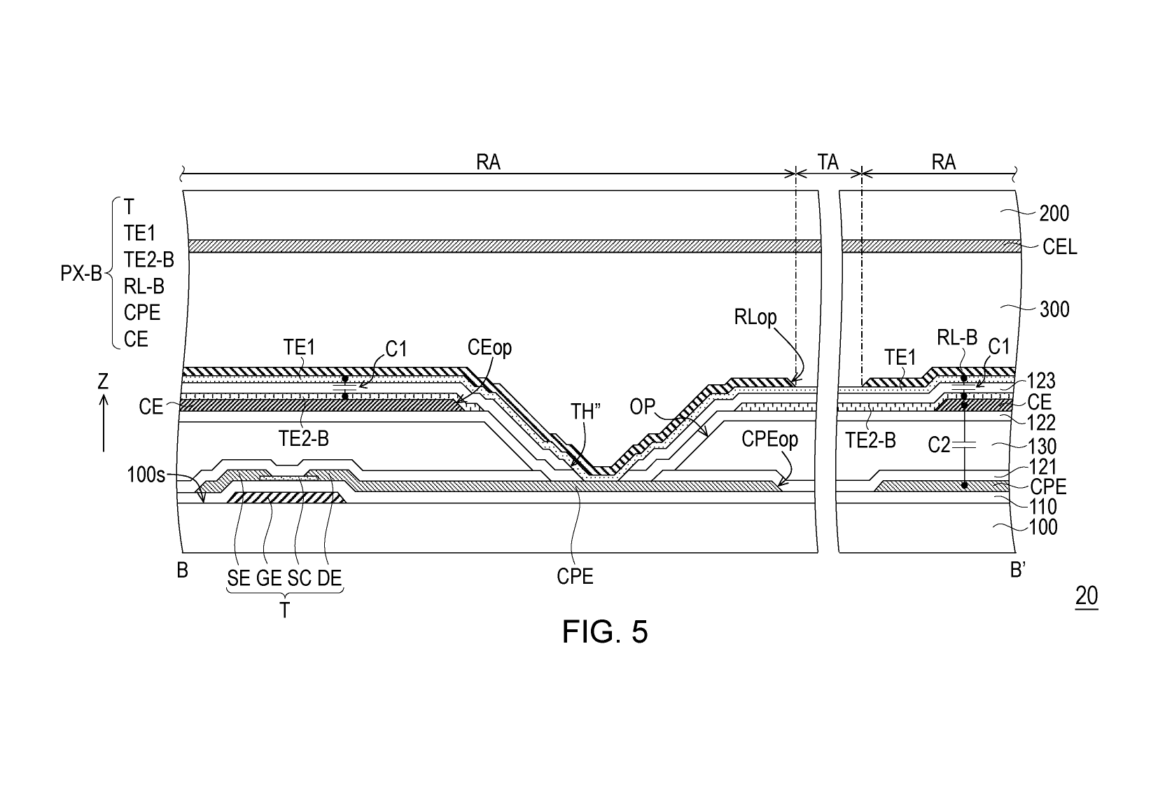

FIG. 4 is a schematic front view of a display panel according to a third embodiment of the disclosure. FIG. 5 is a schematic cross-sectional view of the display panel of FIG. 4. For clarity, FIG. 4 omits the illustrations of the second substrate 200 and the liquid crystal layer 300 in FIG. 5.

Referring to FIG. 4 and FIG. 5, the main difference between a display panel 20 of the embodiment and the display panel 10 of FIG. 1 and FIG. 2 lies in that the pixel structure is different. Specifically, in the display panel 20 of the embodiment, the pixel structure PX-B may further include a common electrode CE, a capacitor electrode CPE and an insulation layer 123. The common electrode CE is disposed between the overcoat layer 130 and the first transparent electrode TE1, and is located in the reflective area RA. The capacitor electrode CPE is located in the reflective area RA and extends from the drain electrode DE of the active device T. The insulation layer 123 is disposed between the common electrode CE and the first transparent electrode TE1.

In the embodiment, the second transparent electrode TE2-B and the common electrode CE are disposed between the insulation layer 122 and the insulation layer 123, and the second transparent electrode TE2-B directly contacts the common electrode CE in the reflective area RA. For example, in the embodiment, the common electrode CE may be disposed between the second transparent electrode TE2-B and the insulation layer 122, but the disclosure is not limited thereto. In other embodiments, the second transparent electrode TE2-B may be disposed between the common electrode CE and the insulation layer 122. The common electrode CE may receive a common voltage, but the disclosure is not limited thereto.

It is particularly noted that, in the embodiment, in addition to a storage capacitor C1 formed by the electrical coupling between the first transparent electrode TE1 and the second transparent electrode TE2-B in the reflective area RA and the transmissive area TA, the common electrode CE and the capacitor electrode CPE can also be electrically coupled to form another storage capacitor C2 in the reflective area RA. More specifically, the storage capacitor of the pixel structure PX-B of the embodiment is formed by connecting the storage capacitor C1 and the storage capacitor C2 in parallel. From another point of view, when the range of the transmissive area TA of the pixel structure PX-B increases, the storage capacitance shortage caused by the reduction of the range of the reflective area RA can be compensated not only by the arrangement of the common electrode CE and the capacitor electrode CPE, but also by utilizing the storage capacitor formed by the first transparent electrode TE1 and the second transparent electrode TE2-B in the transmissive area TA to further enhance the overall storage capacitance of the pixel structure PX-B. Therefore, the ratio adjustment between the reflective area RA and the transmissive area TA of the pixel structure PX-B is no longer restricted by the demand for storage capacitors, which helps to increase the design flexibility of the pixel structure PX-B when taking into account both optical and electrical performance.

On the other hand, in the embodiment, the capacitor electrode CPE, the common electrode CE and the reflective layer RL-B respectively have an opening CPEop, an opening CEop and an opening RLop located in the transmissive area TA. The insulation layer 121, the insulation layer 122 and the insulation layer 123 have a through hole TH” overlapping the opening OP of the overcoat layer 130, and the first transparent electrode TE1 and the reflective layer RL-B can be electrically connected to the capacitor electrode CPE via the opening OP of the overcoat layer 130 and the through hole TH” of the insulation layer 121, the insulation layer 122 and the insulation layer 123.

For considerations of conductivity, the common electrode CE and the capacitor electrode CPE are generally made of metal (such as molybdenum, aluminum, copper, nickel, chromium), alloys, metal nitrides, metal oxides, metal oxynitrides, or other suitable materials, or stacked layers of metal materials and other conductive materials. The insulation layer 123 is, for example, an inorganic insulation layer, and its material includes, for example, silicon nitride, silicon oxide, or aluminum oxide, but the disclosure is not limited thereto.

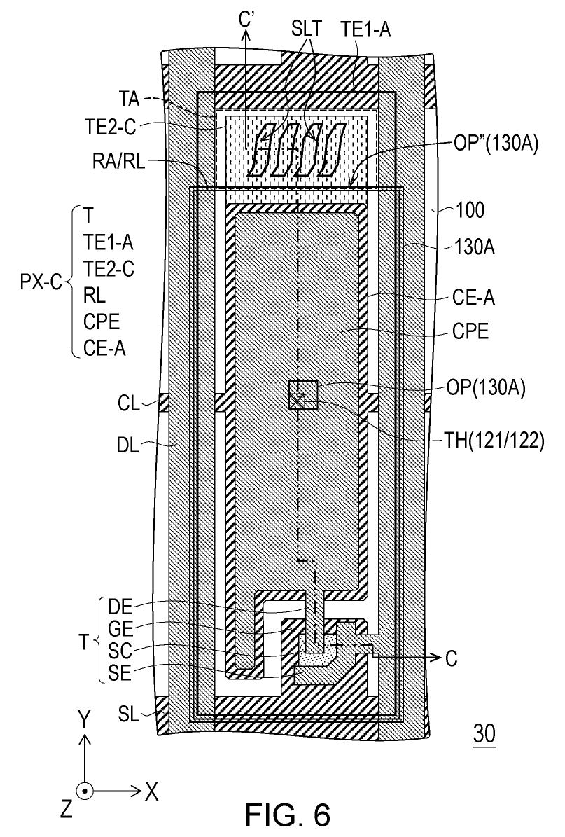

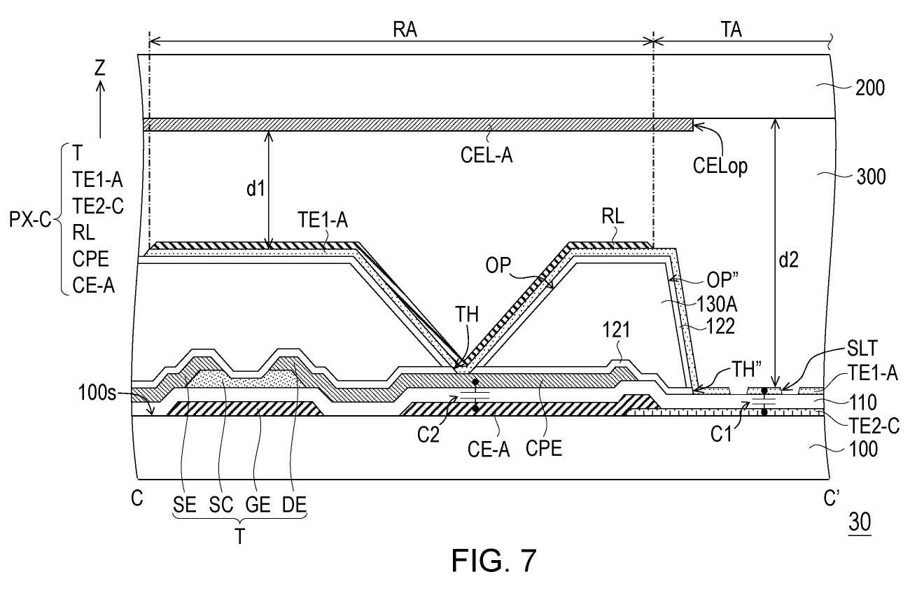

FIG. 6 is a schematic front view of a display panel according to a fourth embodiment of the disclosure. FIG. 7 is a schematic cross-sectional view of the display panel of FIG. 6. FIG. 7 corresponds to a section line C-C’ of FIG. 6. For clarity, FIG. 6 omits the illustrations of the second substrate 200 and the liquid crystal layer 300 in FIG. 7.

Referring to FIG. 6 and FIG. 7, the main difference between a display panel 30 of the embodiment and the display panel 10 of FIG. 1 and FIG. 2 lies in that the configurations of the second transparent electrode and the overcoat layer are different. Specifically, in the display panel 30 of the embodiment, the second transparent electrode TE2-C of the pixel structure PX-C is disposed between the overcoat layer 130A and the first substrate 100, and is substantially located in the transmissive area TA.

In the embodiment, the pixel structure PX-C may further include a capacitor electrode CPE and a common electrode CE-A disposed in the reflective area RA. The capacitor electrode CPE may extend from the drain electrode DE of the active device T. The common electrodes CE of two adjacent pixel structures PX arranged along the direction X may be electrically connected to each other via a common electrode connection line CL, but the disclosure is not limited thereto. Different from the display panel 20 of FIG. 5, the common electrode CE-A and the gate electrode GE of the active device T in the embodiment can be formed in the same metal layer. That is, the common electrode CE-A is disposed between the capacitor electrode CPE and the first substrate 100.

It is particularly noted that the second transparent electrode TE2-C may extend into the reflective area RA and directly contact the common electrode CE-A. For example, in the embodiment, the second transparent electrode TE2 -C may be formed before the formation of the common electrode CE-A. That is, the common electrode CE-A may cover the second transparent electrode TE2-C. However, the disclosure is not limited thereto. In another variant embodiment, the second transparent electrode TE2-C may be formed after the formation of the common electrode CE-A, i.e., the second transparent electrode TE2-C may cover the common electrode CE-A.

On the other hand, in the embodiment, in addition to having the opening OP used to achieve the electrical connection between the first transparent electrode TE1-A and the capacitor electrode CPE, the overcoat layer 130A may further have an opening OP” located in the transmissive area TA. The first transparent electrode TE1-A can directly cover the portion of the gate insulation layer 110 exposed by the opening OP” through the opening OP” of the overcoat layer 130A and the through hole TH” of the insulation layer 121 and the insulation layer 122. That is, only the gate insulation layer 110 is disposed between the first transparent electrode TE1-A and the second transparent electrode TE2-C.

Similar to the display panel 20 of FIG. 5, the first transparent electrode TE1-A can be electrically coupled with the second transparent electrode TE2-C in the transmissive area TA to form a storage capacitor C1, and the common electrode CE-A can be electrically coupled with the capacitor electrode CPE in the reflective area RA to form another storage capacitor C2.

More specifically, the storage capacitor of the pixel structure PX-C of the embodiment is formed by connecting the storage capacitor C1 and the storage capacitor C2 in parallel. From another point of view, when the range of the transmissive area TA of the pixel structure PX-C increases, the storage capacitance shortage caused by the reduction of the range of the reflective area RA can be compensated not only by the arrangement of the common electrode CE-A and the capacitor electrode CPE, but also by utilizing the storage capacitor formed by the first transparent electrode TE1-A and the second transparent electrode TE2-C in the transmissive area TA to further enhance the overall storage capacitance of the pixel structure PX-C. Therefore, the ratio adjustment between the reflective area RA and the transmissive area TA of the pixel structure PX-C is no longer restricted by the demand for storage capacitors, which helps to increase the design flexibility of the pixel structure PX-C when taking into account both optical and electrical performance.

Furthermore, since the overcoat layer 130A of the embodiment is provided with the opening OP” in the transmissive area TA, a thickness d2 of the liquid crystal layer 300 in the transmissive area TA may be greater than a thickness d1 of the liquid crystal layer 300 in the reflective area RA, wherein the thickness d1 and the thickness d2 of the liquid crystal layer 300 are, for example, defined along the normal direction (e.g., direction Z) of the substrate surface 100s. Accordingly, the display panel 30 can achieve the best display effect in both the reflective area RA and the transmissive area TA.

On the other hand, in the embodiment, the first transparent electrode TE1-A may be provided with a plurality of micro slits SLT in the transmissive area TA, and the common electrode layer CEL-A has an electrode opening CELop overlapping the transmissive area TA. More specifically, unlike the portion of the liquid crystal layer 300 in the reflective area RA which is driven by a vertical electric field formed between the common electrode layer CEL-A and the first transparent electrode TE1-A, the portion of the liquid crystal layer 300 in the transmissive area TA is driven by a horizontal electric field formed between the portion of the first transparent electrode TE1-A having the micro slits SLT and the second transparent electrode TE2-C. Since the liquid crystal layer 300 is driven by the horizontal electric field in the transmissive area TA, the viewing angle range of the display panel 30 can be further improved.

For example, in the embodiment, the common electrode CE-A and the second transparent electrode TE2-C may receive a common voltage, but the disclosure is not limited thereto. That is, the driving mode of the pixel structure PX-C in the transmissive area TA of the embodiment adopts a bottom-com architecture.

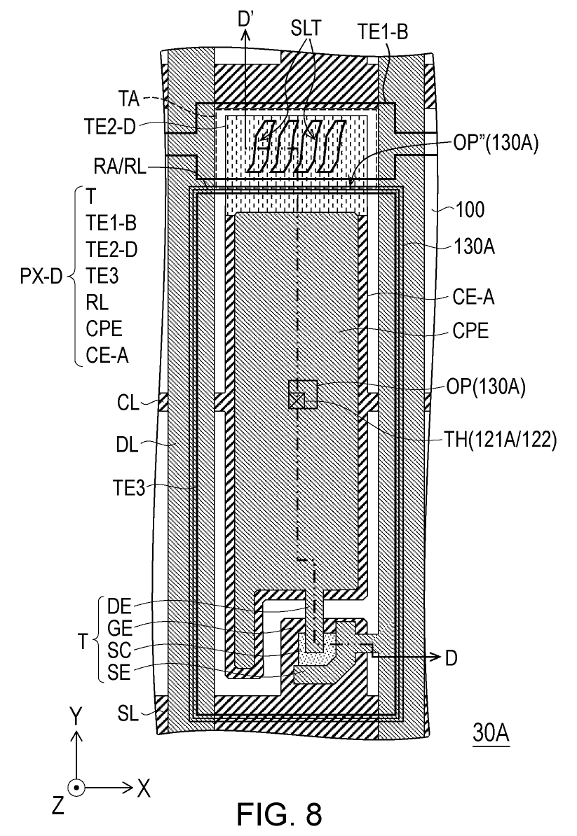

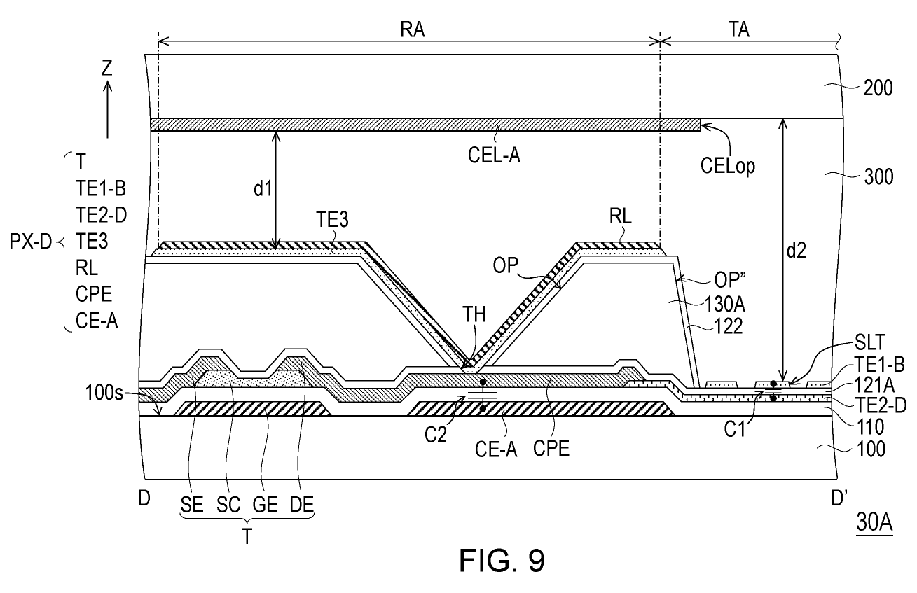

FIG. 8 is a schematic front view of a display panel according to a fifth embodiment of the disclosure. FIG. 9 is a schematic cross-sectional view of the display panel of FIG. 8. FIG. 9 corresponds to a section line D-D’ of FIG. 8. For clarity, FIG. 8 omits the illustrations of the second substrate 200 and the liquid crystal layer 300 in FIG. 9.

Referring to FIG. 8 and FIG. 9, the main difference between a display panel 30A of the embodiment and the display panel 30 of FIG. 6 and FIG. 7 lies in that the configuration of the first transparent electrode and the second transparent electrode is different. In the display panel 30A of the embodiment, the first transparent electrode TE1-B of the pixel structure PX-D is only located in the transmissive area TA and is disposed on the insulation layer 121A. The second transparent electrode TE2-D is disposed between the gate insulation layer 110 and the insulation layer 121A, and is electrically connected to the capacitor electrode CPE. Only an insulation layer 121A is provided between the first transparent electrode TE1-B and the second transparent electrode TE2-D.

For example, in the embodiment, the second transparent electrode TE2-D may be formed before the formation of the capacitor electrode CPE. That is, the capacitor electrode CPE may cover the second transparent electrode TE2-D. However, the disclosure is not limited thereto. In another variant embodiment, the second transparent electrode TE2-D may be formed after the formation of the capacitor electrode CPE, that is, the second transparent electrode TE2-D may cover the capacitor electrode CPE.

It is particularly noted that, in the embodiment, the pixel structure PX-D may further include a third transparent electrode TE3, which is disposed overlapping the reflective area RA. The third transparent electrode TE3 is disposed between the overcoat layer 130A and the reflective layer RL, and is electrically connected to the capacitor electrode CPE via the opening OP of the overcoat layer 130A and the through hole TH of the insulation layer 121A and the insulation layer 122. In the embodiment, the third transparent electrode TE3 and the first transparent electrode TE1-B may be formed in the same film layer and are electrically independent of each other. That is, the first transparent electrode TE1-B of the embodiment is not electrically connected to the capacitor electrode CPE and the drain electrode DE of the active device T. For example, in the embodiment, the first transparent electrode TE1-B and the common electrode CE-A may receive a common voltage, but the disclosure is not limited thereto. Therefore, the driving mode of the pixel structure PX-D in the transmissive area TA of the embodiment adopts a top-com architecture.

Similar to the display panel 30 of FIG. 7, the first transparent electrode TE1-B may be electrically coupled with the second transparent electrode TE2-D in the transmissive area TA to form a storage capacitor C1, and the common electrode CE-A may be electrically coupled with the capacitor electrode CPE in the reflective area RA to form another storage capacitor C2. More specifically, the storage capacitor of the pixel structure PX-D of the embodiment is formed by connecting the storage capacitor C1 and the storage capacitor C2 in parallel. From another point of view, when the range of the transmissive area TA of the pixel structure PX-D increases, the storage capacitance shortage caused by the reduction of the range of the reflective area RA can be compensated not only by the arrangement of the common electrode CE-A and the capacitor electrode CPE, but also by utilizing the storage capacitor formed by the first transparent electrode TE1-B and the second transparent electrode TE2-D in the transmissive area TA to further enhance the overall storage capacitance of the pixel structure PX-D. Therefore, the ratio adjustment of the reflective area RA and the transmissive area TA of the pixel structure PX-D is no longer restricted by the demand for storage capacitors, which helps to increase the design flexibility of the pixel structure PX-D when taking into account both optical and electrical performance.

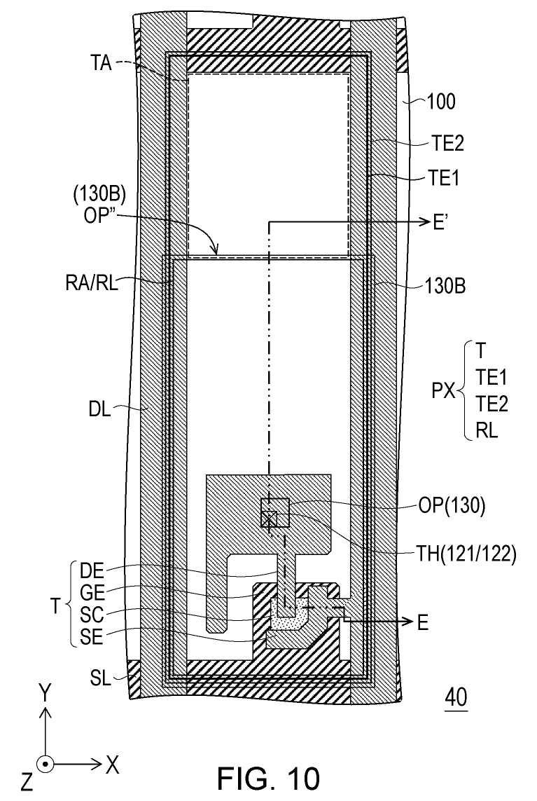

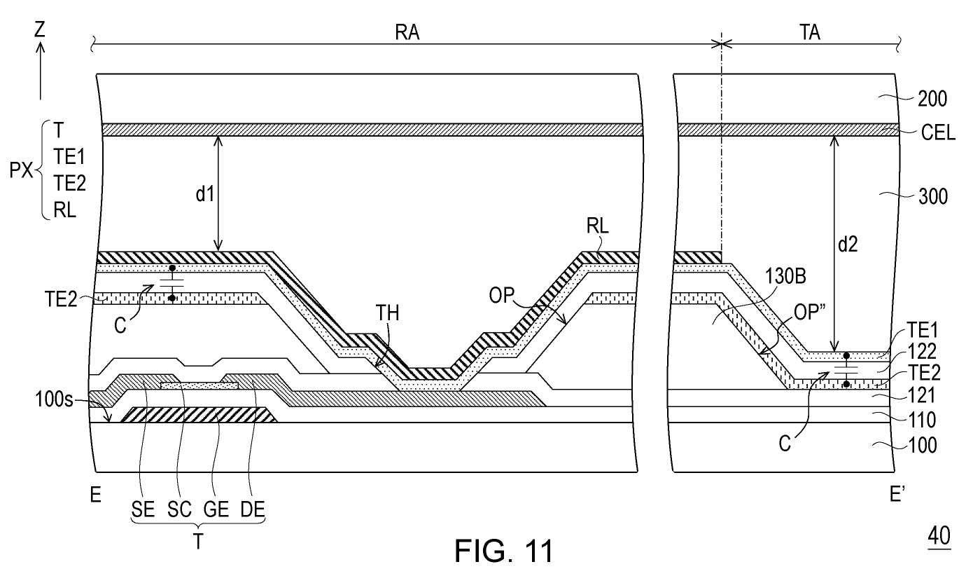

FIG. 10 is a schematic front view of a display panel according to a sixth embodiment of the disclosure. FIG. 11 is a schematic cross-sectional view of the display panel of FIG. 10. FIG. 11 corresponds to a section line E-E’ of FIG. 10. For clarity, FIG. 10 omits the illustrations of the second substrate 200 and the liquid crystal layer 300 in FIG. 11.

Referring to FIG. 10 and FIG. 11, the difference between a display panel 40 of the embodiment and the display panel 10 of FIG. 1 and FIG. 2 lies in that the configuration of the overcoat layer is different. Specifically, in the display panel 40 of the embodiment, in addition to having the opening OP used to achieve the electrical connection between the first transparent electrode TE1 and the drain electrode DE, the overcoat layer 130B may further have an opening OP” located in the transmissive area TA. The second transparent electrode TE2 may directly cover the portion of the insulation layer 121 exposed by the opening OP” through the opening OP” of the overcoat layer 130A.

Since the overcoat layer 130B of the embodiment is provided with the opening OP” in the transmissive area TA, a thickness d2 of the liquid crystal layer 300 in the transmissive area TA may be greater than a thickness d1 of the liquid crystal layer 300 in the reflective area RA, wherein the thickness d1 and the thickness d2 of the liquid crystal layer 300 are, for example, defined along the normal direction (e.g., direction Z) of the substrate surface 100s. Accordingly, the display panel 40 can achieve the best display effect in both the reflective area RA and the transmissive area TA.

On the other hand, since the storage capacitor C of the embodiment can be arranged to overlap both the transmissive area TA and the reflective area RA, the ratio adjustment between the reflective area RA and the transmissive area TA of the pixel structure PX is no longer restricted by the demand for the storage capacitor C, which helps to increase the design flexibility of the pixel structure PX when taking into account both optical and electrical performance.

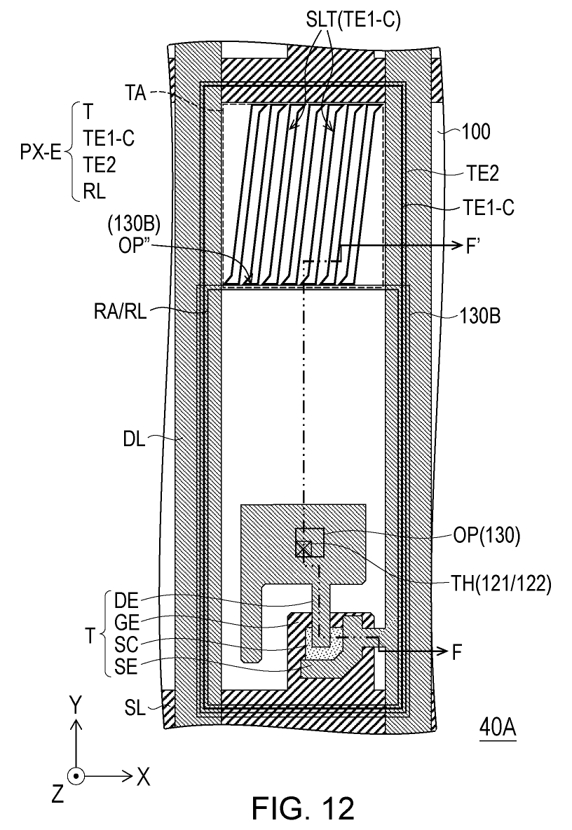

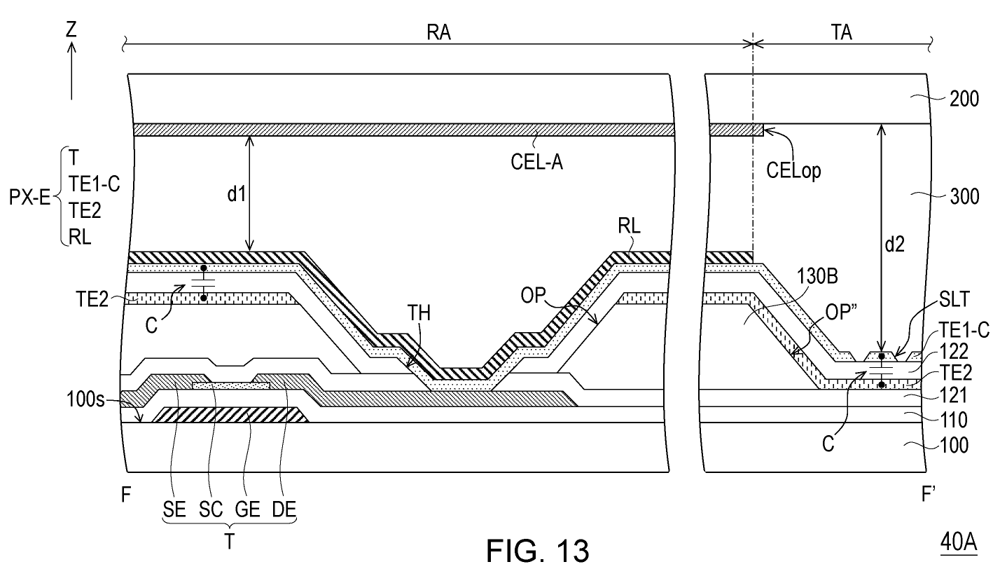

FIG. 12 is a schematic front view of a display panel according to a seventh embodiment of the disclosure. FIG. 13 is a schematic cross-sectional view of the display panel of FIG. 12. FIG. 13 corresponds to a section line F-F’ of FIG. 12. For clarity, FIG. 12 omits the illustrations of the second substrate 200 and the liquid crystal layer 300 in FIG. 13.

Referring to FIG. 12 and FIG. 13, the main difference between a display panel 40A of the embodiment and the display panel 40 of FIG. 10 and FIG. 11 lies in that the configuration of the first transparent electrode in the transmissive area TA is different. For example, in the display panel 40A of the embodiment, the first transparent electrode TE1-C of the pixel structure PX-E may be provided with a plurality of micro slits SLT in the transmissive area TA, and the common electrode layer CEL-A has an electrode opening CELop overlapping the transmissive area TA.

More specifically, unlike the portion of the liquid crystal layer 300 in the reflective area RA which is driven by a vertical electric field formed between the common electrode layer CEL-A and the first transparent electrode TE1-A, the portion of the liquid crystal layer 300 in the transmissive area TA is driven by a horizontal electric field formed between the portion of the first transparent electrode TE1-A having the micro slits SLT and the second transparent electrode TE2-C. Since the liquid crystal layer 300 is driven by the horizontal electric field in the transmissive area TA, the viewing angle range of the display panel 40A can be further improved.

For example, in the embodiment, the second transparent electrode TE2 may receive a common voltage, but the disclosure is not limited thereto. That is, the driving mode of the pixel structure PX-E in the transmissive area TA of the embodiment adopts the bottom-com architecture.

On the other hand, since the storage capacitor C of the embodiment can be arranged to overlap both the transmissive area TA and the reflective area RA, the ratio adjustment between the reflective area RA and the transmissive area TA of the pixel structure PX-E is no longer restricted by the demand for the storage capacitor C, which helps to increase the design flexibility of the pixel structure PX-E when taking into account both optical and electrical performance.

To sum up, in a display panel according to an embodiment of the disclosure, a transmissive are of a pixel structure is provided with a first transparent electrode and a second transparent electrode. The first transparent electrode is electrically coupled with the second transparent electrode to form a storage capacitor electrically connected to an active device. Since the storage capacitor can be arranged to overlap the transmissive area, the ratio adjustment between a reflective area and the transmissive area of the pixel structure is no longer restricted by the demand for a storage capacitor, which helps to increase the design flexibility of the pixel structure when taking into account both optical and electrical performance.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display panel, comprising:
a first substrate;
a pixel structure, disposed on the first substrate and provided with a reflective area and a transmissive area, wherein the pixel structure includes:
an active device;
a first transparent electrode, disposed overlapping the transmissive area;
a reflective layer, disposed on the active device and defining the reflective area; and
a second transparent electrode, disposed overlapping the transmissive area and located between the first transparent electrode and the first substrate; and
an insulation layer, disposed between the first transparent electrode and the second transparent electrode, wherein the first transparent electrode or the second transparent electrode is electrically connected to the active device, and the first transparent electrode is electrically coupled with the second transparent electrode to form a storage capacitor.

2. The display panel according to claim 1, wherein the first transparent electrode and the second transparent electrode are arranged to overlap the reflective area, and the first transparent electrode is electrically connected to the active device.

3. The display panel according to claim 2, further comprising:
an overcoat layer, disposed between the first transparent electrode and the first substrate and covering the active device, wherein the second transparent electrode is disposed between the insulation layer and the overcoat layer.

4. The display panel according to claim 3, wherein the pixel structure further includes:
a common electrode, disposed between the overcoat layer and the first transparent electrode and located in the reflective area, and the second transparent electrode extends into the reflective area and directly contacts the common electrode.

5. The display panel according to claim 4, wherein the pixel structure further includes:
a capacitor electrode, located in the reflective area and extending from a drain electrode of the active device, wherein the common electrode is electrically coupled with the capacitor electrode to form another storage capacitor.

6. The display panel according to claim 3, further comprising:
a second substrate, disposed overlapping the first substrate;
a common electrode layer, disposed on the second substrate; and
a liquid crystal layer, disposed between the first substrate and the second substrate, wherein the overcoat layer has an opening located in the transmissive area, and a thickness of the liquid crystal layer in the transmissive area is greater than a thickness of the liquid crystal layer in the reflective area.

7. The display panel according to claim 6, wherein the first transparent electrode is provided with a plurality of micro slits in the transmissive area, and the common electrode layer has an electrode opening overlapping the transmissive area.

8. The display panel according to claim 1, wherein the reflective layer and the second transparent electrode are the same film layer and are electrically connected to each other.

9. The display panel according to claim 8, wherein a thickness of the second transparent electrode is less than a thickness of the reflective layer.

10. The display panel according to claim 8, wherein the materials of the second transparent electrode and the reflective layer include silver.

11. The display panel according to claim 8, wherein the first transparent electrode is electrically coupled with the reflective layer to form another storage capacitor.

12. The display panel according to claim 1, further comprising:
an overcoat layer, disposed between the first transparent electrode and the first substrate, and covering the active device, wherein the overcoat layer has an opening located in the transmissive area, and the second transparent electrode is disposed between the overcoat layer and the first substrate.

13. The display panel according to claim 12, further comprising:
a second substrate, disposed overlapping the first substrate;
a common electrode layer, disposed on the second substrate; and
a liquid crystal layer, disposed between the first substrate and the second substrate, wherein a thickness of the liquid crystal layer in the transmissive area is greater than a thickness of the liquid crystal layer in the reflective area.

14. The display panel according to claim 13, wherein the first transparent electrode is provided with a plurality of micro slits in the transmissive area, and the common electrode layer has an electrode opening overlapping the transmissive area.

15. The display panel according to claim 12, wherein the pixel structure further includes:
a capacitor electrode, located in the reflective area and extending from a drain electrode of the active device; and
a common electrode, disposed between the capacitor electrode and the first substrate and located in the reflective area, wherein the common electrode overlaps the capacitor electrode.

16. The display panel according to claim 15, wherein the first transparent electrode extends into the reflective area and is electrically connected to the capacitor electrode, the second transparent electrode is electrically connected to the common electrode, and the capacitor electrode is electrically coupled with the common electrode to form another storage capacitor.

17. The display panel according to claim 15, wherein the pixel structure further includes:
a third transparent electrode, disposed overlapping the reflective area and electrically connected to the capacitor electrode.

18. The display panel according to claim 17, wherein the first transparent electrode and the third transparent electrode are the same film layer and are electrically independent of each other.

19. The display panel according to claim 17, wherein the second transparent electrode is electrically connected to the capacitor electrode, and the capacitor electrode is electrically coupled with the common electrode to form another storage capacitor.

20. The display panel according to claim 1, wherein the first transparent electrode extends into the reflective area and is electrically connected to the reflective layer.
